(19) United States
(12) Patent Application Publication
(10) Pub. No.: US 2025/0335676 A1
(43) Pub. Date: Oct. 30, 2025

(54) DESIGN METHOD FOR DECREASING RANDOM TELEGRAPH NOISE (RTN) IN CIRCUIT

(71) Applicant: TAIWAN SEMICONDUCTOR MANUFACTURING COMPANY LTD., HSINCHU (TW)

(72) Inventors: CHI-FENG HUANG, HSINCHU COUNTY (TW); FU-HUAN TSAI, KAOHSIUNG CITY (TW); YOU-TAI CHANG, HSINCHU CITY (TW); MENG-LIN LU, KEELUNG CITY (TW); CHENG-HSIANG HSIEH, TAIPEI CITY (TW)

(21) Appl. No.: 18/646,803

(22) Filed: Apr. 26, 2024

(51) Int. Cl. G06F 30/3308; H05K 3/00

(52) U.S. Cl. CPC G06F 30/3308; H05K 3/0005

(57) ABSTRACT

A design method is provided. Design data of a circuit is received, and the circuit is configured to perform a function. A simulation is performed based on the design data of the circuit to obtain an output corresponding to the function. The circuit is modified by adding additional devices in series with at least one problematic transistor in the circuit when random telegraph noise (RTN) of the output does not meet a design specification. A layout of the modified circuit is generated when the RTN of the output of the modified circuit meets the design specification.

### BACKGROUND

Random telegraph noise (RTN) can occur in various types of semiconductor devices, such as transistors, image sensors, and/or the like. RTN causes random step-like transitions between two or more discrete voltage or current levels, such as a threshold voltage, a drain current, and/or the like.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a flowchart of a design method for an IC, in accordance with some embodiments of the present disclosure.

FIG. 2 shows a circuit of an amplifier, in accordance with some embodiments of the present disclosure.

FIG. 3 shows a modified circuit of the amplifier of FIG. 2, in accordance with some embodiments of the present disclosure.

FIG. 4A is a schematic diagram showing the relationship between random telegraph noise (RTN) cumulative distribution function (CDF) and root mean square (RMS) of voltage with correlated double sampling (CDS) of problematic transistor without additional device.

FIG. 4B is a schematic diagram showing the relationship between RTN CDF and RMS of voltage with CDS of problematic transistor with additional device.

FIG. 5 shows a modified circuit of the amplifier of FIG. 2, in accordance with some embodiments of the present disclosure.

FIG. 6 shows a modified circuit of the amplifier of FIG. 2, in accordance with some embodiments of the present disclosure.

FIG. 7 is a schematic diagram showing the relationship between RTN CDF and RMS of the output signal with CDS of the amplifier.

FIG. 8A is a schematic diagram showing an IC manufacturing system, in accordance with some embodiments of the present disclosure.

FIG. 8B is a schematic diagram of the design system for implementing or storing the circuits discussed in accordance with some embodiments of the present disclosure.

### DETAILED DESCRIPTION

The following disclosure provides many different embodiments, or examples, for implementing different features of the provided subject matter. Specific examples of components and arrangements are described to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

While embodiments of the present disclosure are discussed in detail, it should be appreciated that the present disclosure provides many applicable inventive concepts that can be embodied in a wide variety of specific contexts. The specific embodiments discussed are merely illustrative and do not limit the scope of the disclosure.

Further, spatially relative terms, such as “beneath,” “below,” “lower,” “above,” “upper,” “lower,” “left,” “right” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. It should be understood that when an element is referred to as being “connected to” or “coupled to” another element, it may be directly connected to or coupled to the other element, or intervening elements may be present.

Random telegraph noise (RTN), also referred to as burst noise, popcorn noise, impulse noise, bi-stable noise, or random telegraph signal (RTS) noise, is a type of electronic noise that occurs in some semiconductor devices with thin gate oxide films. It typically manifests as abrupt transitions in operating voltage and/or electric current level. RTN is an important characteristic parameter for high performance radio frequency (RF) and analogue electronics applications. RTN can include sudden step-like transitions between two or more discrete voltage or current levels, as high as several hundred microvolts, at random and unpredictable times. Each shift in offset voltage or current often lasts from several milliseconds to seconds. Disclosed herein are methods for decreasing RTN in circuits.

Advances in semiconductor technology in recent years have enabled the reduction of minimum device feature sizes to a scaled-down range. RTN is one observed effect in such scaled-down transistors. Physical defects within the gate dielectric of the transistors can trap charge during device operation, typically in response to bias on the transistor; other bias conditions or thermal effects can later “de-trap” or release that trapped charge. The trapping and de-trapping of charge via this mechanism is essentially a random process over time. This trapping and de-trapping mechanism has an electrical effect of modulating the threshold voltage of the transistor. With the extremely small feature sizes and extremely thin gate dielectrics in the transistors, the trapping and de-trapping of even a single charge within the gate dielectric is reflected by variations in the small transistor threshold voltage. This mechanism can also cause fluctuations in the gate leakage of the transistor, with or without noticeable threshold voltage modulation.

Various design methods for decreasing RTN of gate induced drain leakage current (GIDL) for noise sensitive circuit are provided in accordance with various exemplary embodiments. Some variations of some embodiments are discussed.

Throughout the various views and illustrative embodiments, like reference numbers are used to designate like elements.

According to the embodiments of the present disclosure, when the transistor suffering RTN of gate induced drain leakage current (GIDL) (also known as GIDL RTN) is present in a circuit, the circuit is modified by adding an additional device in series with the transistor, so as to decrease the gate-to-drain voltage Vgd of the transistor, thereby decreasing the GIDL RTN for the transistor in the modified circuit. The additional device is a transistor or a resistor. The transistor suffering GIDL RTN is identified from the transistors functioning as switched in the circuit. According to the embodiments of the present disclosure, the additional device has suitable dimension so that RTN of the modified circuit meets a predetermined design specification for a noise sensitive IC.

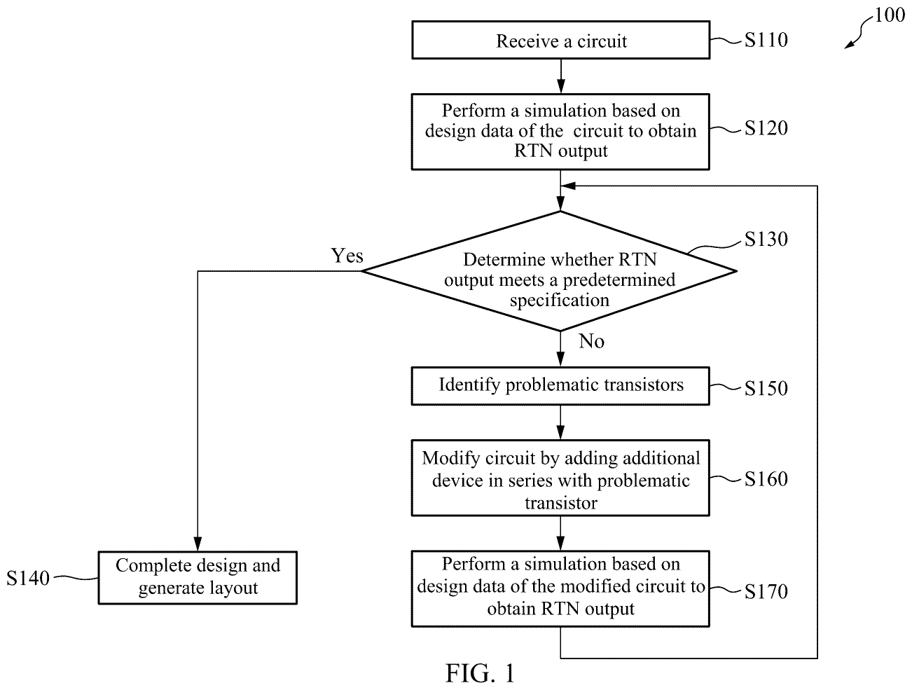

FIG. 1 is a flowchart of a design method 100 for an IC, in accordance with some embodiments of the present disclosure. The IC includes various circuits, and the circuits are capable of performing specific functions of the IC individually or jointly. It should be understood that additional operations can be provided before, during, and after operations shown in FIG. 1, and some of the operations described can be replaced or eliminated in other embodiments of the design method 100. In some embodiments, the order of the operations may be interchangeable.

In some embodiments, the design method 100 may be performed by a computer or processor capable of operating one or more electronic design automation (EDA) tools (or electronic circuit simulators) to design, optimize, and verify semiconductor device designs, such as circuit designs in the IC. According to the design method 100, the EDA tool is operated based on the definition of the circuits of IC that may be provided in a netlist of circuit elements, so as to modify the circuit to mitigate the GIDL RTN. The GIDL RTN is a kind of time variant off-state current caused by a higher external gate-to-drain voltage Vgd applied to the gate and the drain of a transistor, that will cause failure of the circuit or degrade signal-to-noise ratio (SNR) of the circuit. One or more device libraries (or models) are provided that specify characteristics of devices available for use in a physical implementation using a given technology of the circuit elements in the netlist. The entries in the library include performance data such as process models and power models, and other supporting information. After completing the modified circuits, a layout of the IC with the modified circuits is generated, and the IC can be made based on the layout.

In operation S110, design data of a circuit (also called an original circuit) of the IC is received or obtained. The circuit is configured to perform a function in an IC. The circuit includes multiple semiconductor devices, such as transistors, capacitors, resistors and so on. The design data may be represented as a netlist, a schematic diagram, or a circuit diagram of the device units. In some embodiments, design data is generated during a simulation stage or a synthesis stage of a design flow in an electronic circuit design process.

In operation S120, a simulation of the circuit is performed based on the design data obtained in operation S110. After completing the simulation, RTN output of the circuit is obtained. In some embodiments, the RTN output represents a RTN cumulative distribution function (CDF) of an output signal at an output terminal of the circuit. In some embodiments, the RTN output represents a RTN CDF of one or more internal signals within the circuit. In some embodiments, the RTN CDF is obtained by performing the simulation with different operation voltages, bias voltages or currents, temperatures, and/or the like. In some embodiments, the simulation is performed according to a Graphic Design System (GDS) file of the IC having an original layout of the circuit.

In operation S130, it is determined whether the RTN output meets a predetermined design specification of the IC. In a noise sensitive product, e.g., image sensor, true wireless stereo, wireless connectivity product, audio CODEC product, and so on, RTN is severely restricted because GIDL RTN will cause either the failure of trimming circuit due to inadequate design margin or degraded SNR concerned by noise sensitive circuits. If it is determined that the RTN output meets the predetermined design specification, the design method 100 enters operation S140 and the design of the circuit is completed, and a layout of the original circuit is then generated for fabricating the IC. Conversely, if it is determined that the RTN output does not meet the predetermined design specification, the design method 100 enters operation S150.

In operation S150, the problematic transistors are identified from among all transistors in the circuit. The problematic transistors are those that will cause RTN in the circuit. The problematic transistors are identified by selecting the transistors that function as switches in the circuit, and assigning the selected transistors as the problematic transistors. In some embodiments, the problematic transistors are the N-type transistors, because a higher gate-to-drain voltage Vgd will introduce a time-varying band-to-band tunneling current from the drain diode when the N-type transistor is operated in off-state (i.e., a gate voltage Vg is equal to zero).

In operation S160, the circuit is modified by adding additional devices in series with the problematic transistors. In some embodiments, each problematic transistor is connected in series with a corresponding additional device. In some embodiments, only some of the problematic transistors are connected in series with the corresponding additional devices. The additional device may be a resistor or a transistor. In some embodiments, the additional devices are all transistors. In some embodiments, the additional devices are all resistors. In some embodiments, a portion of the additional devices are transistors and the remaining additional devices are resistors. In some embodiments, the problematic transistor is an N-type transistor, and the circuit is modified by replacing the problematic transistor with a P-type transistor. In some embodiments, the additional devices are implemented by the dummy devices in the layout of the circuit. In other words, the existing devices on the IC are used to minimize effort in revising design and layout.

In operation S170, a simulation of the modified circuit is performed based on the design data of the modified circuit having the additional devices. After completing the simulation, a RTN output of the modified circuit is obtained. In some embodiments, the RTN output represents a RTN CDF of the output signal at the output terminal of the modified circuit. In some embodiments, the RTN output represents a RTN CDF of one or more internal signals within the modified circuit.

After the RTN output of the modified circuit is obtained in operation S170, the design method 100 returns to operation S130, so as to determine whether the RTN output of the modified circuit meets the predetermined design specification of the IC. If it is determined that the RTN output meets the predetermined design specification, the design method 100 enters operation S140 and the modification of the circuit is completed, and layout of the modified circuit is generated for fabricating the IC. Conversely, if it is determined that the RTN output does not meet the predetermined design specification, the design method 100 enters operation S150 to perform subsequent operations until the RTN output of the modified circuit does meet the predetermined design specification.

In some embodiments, operation S160 and operation S170 are performed together, so as to determine the additional device for optimization, e.g., the additional device with optimal dimension or size. In some embodiments, a RTN model is used in operations S160 and S170 to determine (or select) the size of the additional device of each problematic transistor, so as to confirm the noise budget of the problematic transistor.

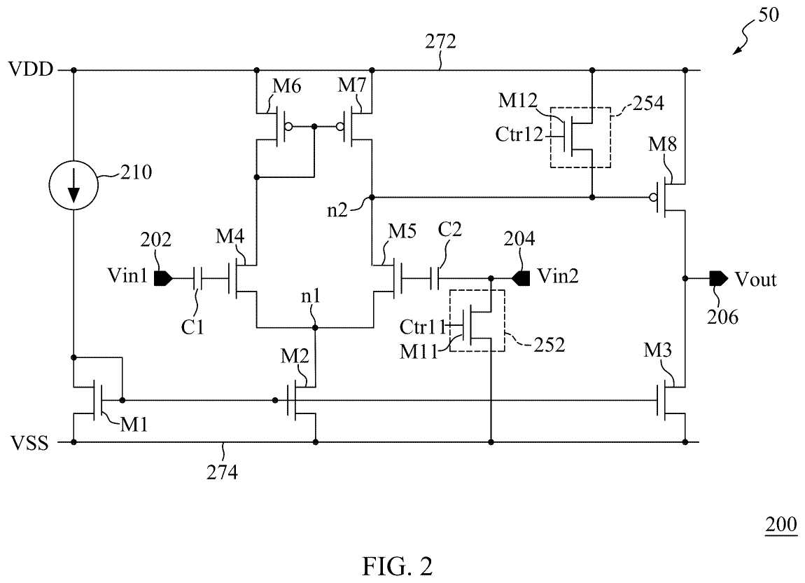

FIG. 2 shows a circuit 200 of an amplifier 50, in accordance with some embodiments of the present disclosure. The amplifier 50 includes a current source 210 and a current mirror circuit consisting of the transistors M1, M2 and M3. The amplifier 50 further includes an input stage consisting of the capacitors C1 and C2 and the transistors M2 and M4, M5, M6 and M7, and an output stage consisting of the transistor M3 and M8. In this embodiment, the transistors M1 through M5 are N-type transistors, and the transistors M6 through M8 are P-type transistors. The circuit 200 is an original circuit for the amplifier 50.

In the circuit 200, the current source 210 is coupled between a power line 272 and the transistor M1. The transistor M1 is coupled between the current source 210 and a ground line 274, and both gate and drain of the transistor M1 are coupled to the current source 210. The gate of transistor M1 is further coupled to the gates of the transistors M2 and M3. The power line 272 is configured to receive a power voltage VDD, and the ground line 274 is configured to receive a ground voltage VSS.

In the input stage of the amplifier 50, the transistors M6 and M4 are connected in series between the power line 272 and a first node n1. The transistor M7 is coupled between the power line 272 and a second node n2, and the transistor M5 is coupled between the second node n2 and the first node n1. The transistor M2 is coupled between the first node n1 and the ground line 274. Both gate and drain of the transistor M6 are coupled to the gate of transistor M7. The capacitor C1 is coupled between the gate of transistor M4 and a first input terminal 202 of the amplifier 50, and the first input terminal 202 receives a first input signal Vin1. The capacitor C2 is coupled between the gate of transistor M5 and a second input terminal 204 of the amplifier 50, and the second input terminal 204 receives a second input signal Vin2. In some embodiments, the first input signal Vin1 and the second input signal Vin2 are a pair of differential signals.

In the output stage of the amplifier 50, the transistor M8 is coupled between the power line 272 and an output terminal 206 of the amplifier 50, and the transistor M3 is coupled between the output terminal 206 and the ground line 274. The output terminal 206 provides an output signal Vout. The amplifier 50 is configured to increase the magnitude of a difference between the first input signal Vin1 and the second input signal Vin2 to provide the output signal Vout in the IC.

The amplifier 50 further includes two switching units 252 and 254. The switching unit 252 is controlled by a control signal Ctrl1, and the switching unit 254 is controlled by a control signal Ctrl2. The switching unit 252 includes the transistor M11, and the transistor M11 is coupled between the second input terminal 204 and the ground line 274. The switching unit 254 includes the transistor M12, and the transistor M12 is coupled between the second node n2 and the power line 272. In this embodiment, the transistors M11 and M12 are N-type transistors function as switches. When the amplifier 50 is enabled, the transistors M11 and M12 are turned off (i.e., at off-state) by the control signals Ctrl1 and Ctrl2, respectively. Conversely, when the amplifier 50 is disabled, the transistors M11 and M12 are turned on (i.e., at on-state) by the control signals Ctrl1 and Ctrl2, respectively. In some embodiments, the transistors M11 and M12 are different sizes. In some embodiments, the transistor M12 has a smaller gate length Lg than the transistor M11.

Referring to FIG. 1 and FIG. 2 together, when the circuit 200 of the amplifier 50 is received by the computer or processor capable of operating the EDA tool, simulation of operation S120 is performed based on the design data including each device in the circuit 200, so as to obtain the RTN output of the circuit 200. In this embodiment, the RTN output represents the RTN CDF of the output signal Vout at the output terminal 206 of the circuit 200. In some embodiments, the RTN output represents the RTN CDF of one or more internal signals in the internal nodes (e.g., the first node n1 and the second node n2) of the circuit 200.

When the RTN output of the circuit 200 does not meet a predetermined design specification of the amplifier 50, operation S150 is performed, and transistors M11 and M12 are then identified as the problematic transistors. As described, a higher gate-to-drain voltage Vgd will introduce a time-varying band-to-band tunneling current from the drain diode when the N-type transistor is operated in off-state (i.e., a gate voltage Vg=0V), that will cause the RTN.

After the transistors M11 and M12 are identified, the circuit 200 is modified in operation S160 and simulation of operation S170 is performed based on the modified circuit for the amplifier 50.

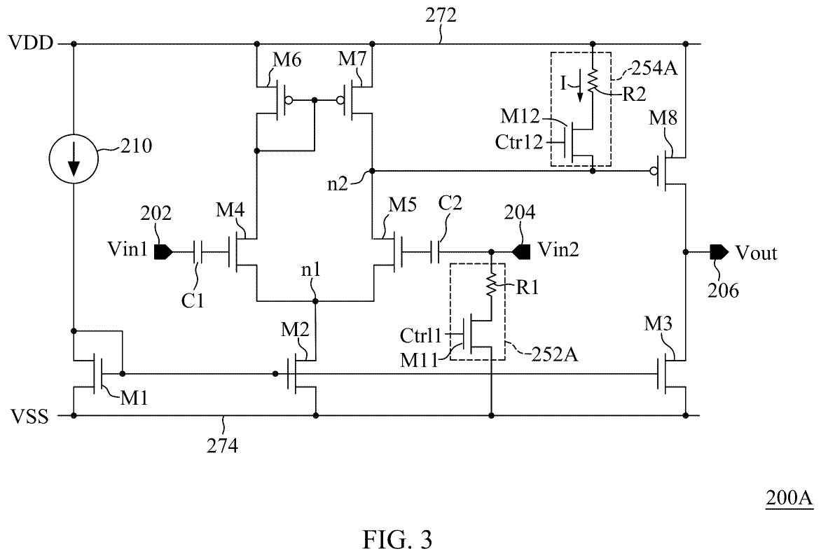

FIG. 3 shows a modified circuit 200A of the amplifier 50, in accordance with some embodiments of the present disclosure. The embodiment of FIG. 3 is obtained according to operations S150, S160 and S170 of the design method 100 of FIG. 1.

In FIG. 3, the modified circuit 200A includes the switching units 252A and 254A. Compared with the switching units 252 and 254 in the circuit 200 of FIG. 2, each of the switching units 252A and 254A further includes a resistor. The resistor R1 is an additional device added to the switching unit 252 to form the switching unit 252A. The resistor R1 is coupled between the drain of transistor M11 and the second input terminal 204. Similarly, the resistor R2 is added to the switching unit 254 to form the switching unit 254A. The resistor R2 is coupled between the drain of transistor M12 and the power line 272. By adding a resistor for each problematic transistor, the voltage drop caused by the current I through the resistor will reduce the drain voltage Vd of the problematic transistor, thereby decreasing the gate-to-drain voltage Vgd of the problematic transistor. Therefore, the lower gate-to-drain voltage Vgd will not introduce GIDL RTN for the problematic transistor. With transistor M12 as an example, the drain voltage Vd of the transistor M12 in the switching unit 254 is equal to the power VDD, and the drain voltage Vd of the transistor M12 in the switching unit 254A is equal to the power VDD minus the voltage drop of the resistor R2, e.g., Vd=VDD−I*R2. In other words, the drain voltage Vd of transistor M12 in the switching unit 254A is less than the drain voltage Vd of transistor M12 in the switching unit 254.

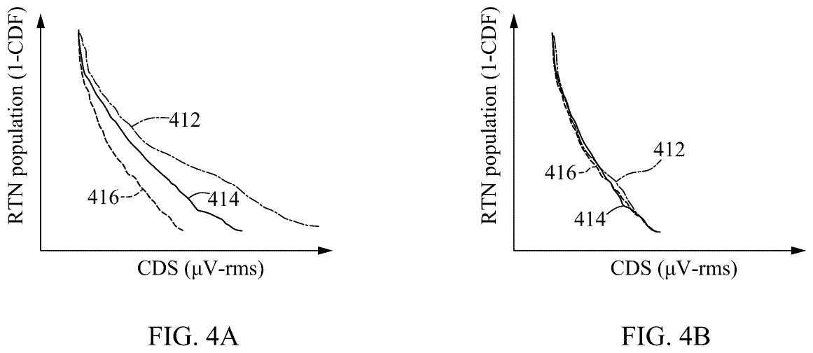

FIG. 4A is a schematic diagram showing the relationship between RTN CDF and RMS (root mean square) of the voltage with correlated double sampling (CDS) of the problematic transistor without the additional device, and FIG. 4B is a schematic diagram showing the relationship between RTN CDF and RMS of the voltage with CDS of the problematic transistor with the additional device. In FIGS. 4A and 4B, the curve 412 represents a RTN simulation of the problematic transistor with the gate-to-drain voltage Vgd of V1. Furthermore, the curve 414 represents a RTN simulation of the problematic transistor with the gate-to-drain voltage Vgd of V2, and the curve 416 represents a RTN simulation of the problematic transistor with the gate-to-drain voltage Vgd of V3. In this embodiment, voltage V2 is lower than voltage V1 and higher than voltage V3. In FIG. 4A, the RTN is changed with different gate-to-drain voltages Vgd, and the curve 416 is better than the curve 414 and the curve 414 is better than the curve 412 because the curve 416 is the steepest curve in CDS with smallest RTN. In FIG. 4B, the curves 412, 414 and 416 converge, such that the different gate-to-drain voltages Vgd do not affect RTN.

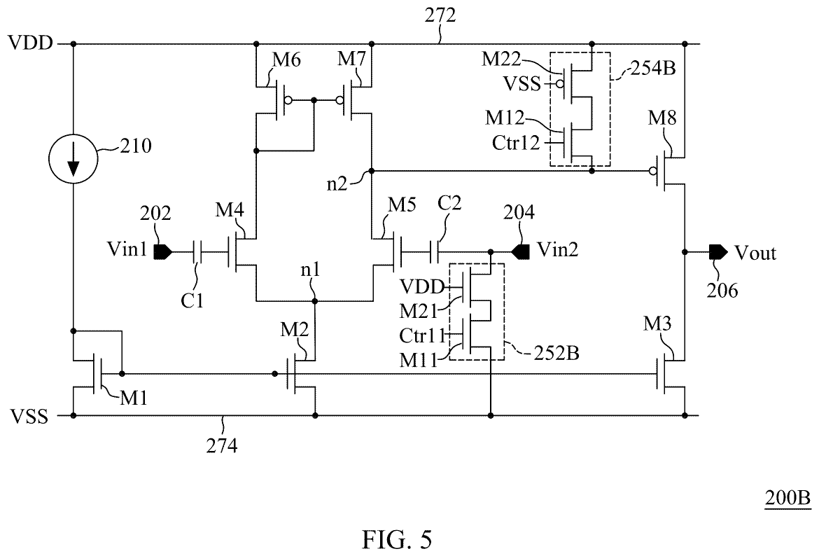

FIG. 5 shows a modified circuit 200B of the amplifier 50, in accordance with some embodiments of the present disclosure. The embodiment of FIG. 5 is obtained according to operations S150, S160 and S170 of the design method 100 in FIG. 1.

In FIG. 5, the modified circuit 200B includes the switching units 252B and 254B. Compared with the switching units 252 and 254 in the circuit 200 of FIG. 2, each of the switching units 252B and 254B further includes a transistor functioning as an on-state switch. The transistor M21 is an additional device that is added to the switching unit 252 to form the switching unit 252B. The transistor M21 is coupled between the drain of transistor M11 and the second input terminal 204. Similarly, the transistor M22 is added to the switching unit 254 to form the switching unit 254B. The transistor M22 is coupled between the drain of transistor M12 and the power line 272, and a gate of transistor M22 is coupled to the ground line 274.

The transistor M21 is an N-type transistor, and a gate of transistor M21 is coupled to the power line 272, thus the transistor M21 is always turned on. The transistor M22 is a P-type transistor, and a gate of transistor M22 is coupled to the ground line 274, thus the transistor M22 is always turned on. In some embodiments, the transistors M11 and M21 are different sizes. For example, transistor M21 is smaller than transistor M11.

The turned-on transistor has an on-resistance providing a voltage drop for decreasing the drain voltage of the problematic transistor, thereby decreasing the gate-to-drain voltage Vgd of the problematic transistor. Therefore, the lower gate-to-drain voltage Vgd will not introduce GIDL RTN for the problematic transistor. With transistor M12 as an example, the drain voltage Vd of the transistor M12 in the switching unit 254 is equal to the power VDD (e.g., Vd=VDD), and the drain voltage Vd of the transistor M12 in the switching unit 254B is equal to the power VDD minus the threshold voltage Vth of the transistor M22 (e.g., Vd=VDD−Vth). In other words, the drain voltage Vd of the transistor M12 in the switching unit 254B is less than the drain voltage Vd of the transistor M12 in the switching unit 254.

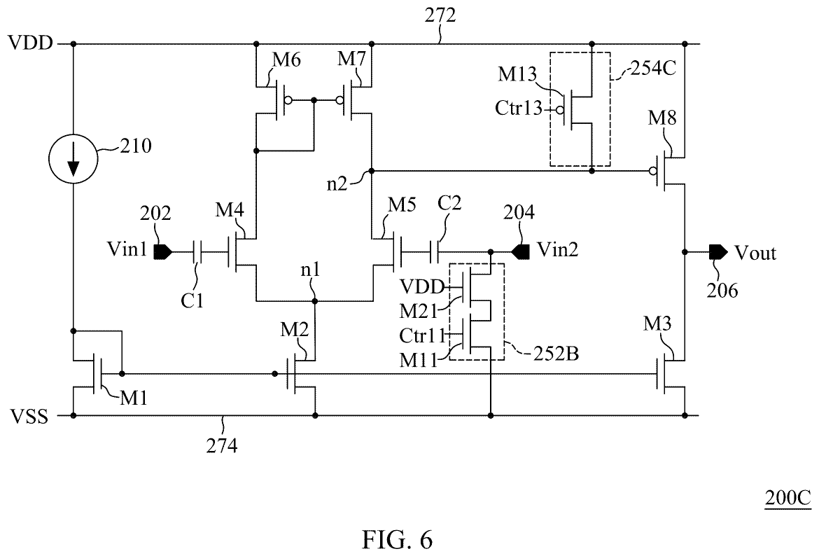

FIG. 6 shows a modified circuit 200C of the amplifier 50, in accordance with some embodiments of the present disclosure. The embodiment of FIG. 6 is obtained according to operations S150, S160 and S170 of the design method 100 in FIG. 1.

In FIG. 6, the modified circuit 200C includes the switching units 252B and 254C. The switching unit 252B is described in FIG. 5 and is omitted herefrom. Compared with the switching unit 254 in the circuit 200 of FIG. 2, the switching unit 254C is switched by a control signal Ctrl3 and includes a P-type transistor M13, i.e., the N-type transistor M12 is replaced with the P-type transistor M13, and no additional device is added. Compared with the N-type transistor, the P-type transistor has a steeper RTN curve than the curves 412, 414 and 416 of FIGS. 4A and 4B. The transistor M13 is coupled between the second node n2 and the power line 272. When the amplifier 50 is enabled, the transistors M11 and M13 are turned off (i.e., at off-state) by the control signals Ctrl1 and Ctrl3, respectively. Conversely, when the amplifier 50 is disabled, the transistors M11 and M13 are turned on (i.e., at on-state) by the control signals Ctrl1 and Ctrl3, respectively.

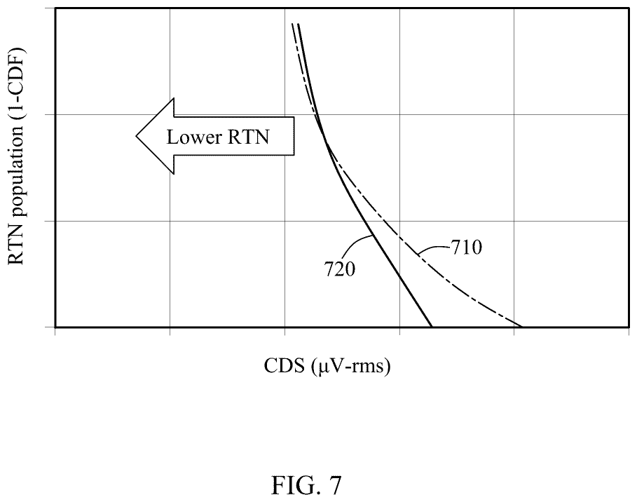

FIG. 7 is a schematic diagram showing the relationship between RTN CDF and RMS of the output signal Vout with CDS of the amplifier 50. In FIG. 7, the curve 710 represents a RTN simulation of the circuit 200 of FIG. 2, and the curve 720 represents a RTN simulation of the modified circuit 200A of FIG. 3, the modified circuit 200B of FIG. 5, or the modified circuit 200C of FIG. 6. As shown in FIG. 7, the modified circuit has lower RTN than the original circuit for the amplifier 50.

By connecting the additional device in series with the transistor potentially introducing GIDL RTN, the gate-to-drain voltage Vgd of the transistor is decreased, thereby decreasing the GIDL RTN for the modified circuit.

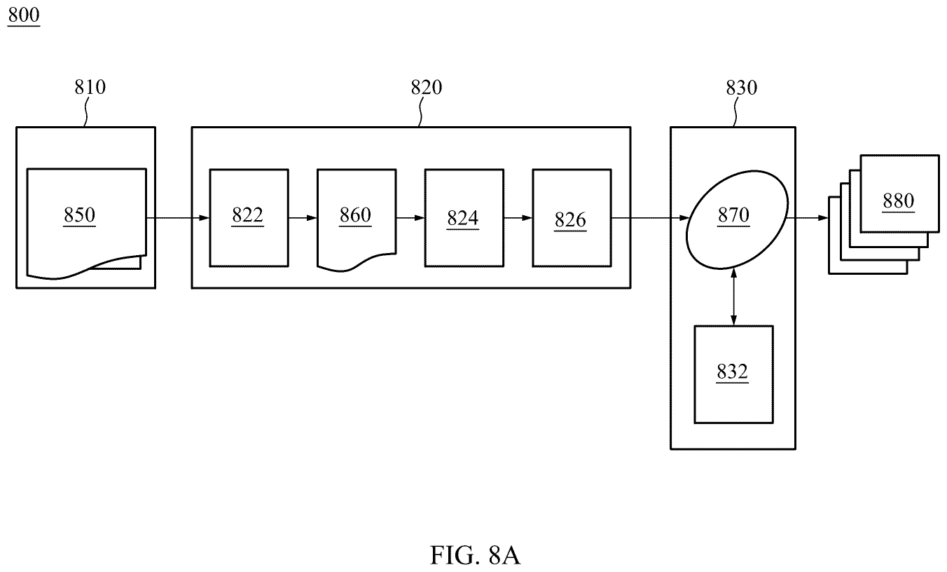

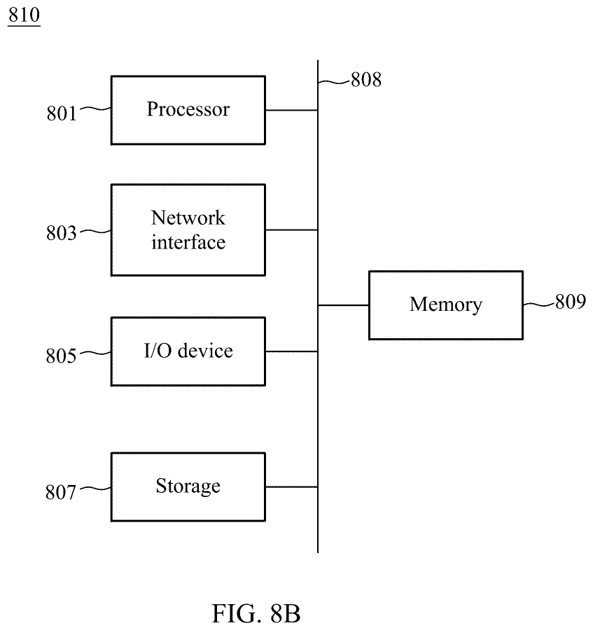

FIG. 8A is a schematic diagram showing an IC manufacturing system 800, in accordance with some embodiments of the present disclosure. The IC manufacturing system 800 is configured to manufacture the IC devices 880 through a plurality of entities, such as a design subsystem 810, a mask subsystem 820, and a fabrication subsystem 830. The entities in the IC manufacturing system 800 may be linked by a communication channel, e.g., a wired or wireless channel, and interact with one another through a network, e.g., an intranet or the internet. In some embodiments, the design subsystem 810, the mask subsystem 820 and the fabrication subsystem 830 are implemented in a single entity, or are operated by independent parties.

The design subsystem 810 may be provided by a design house or a layout design provider, and generates a design layout 850 in a design phase by which the IC devices 880 are fabricated. The design subsystem 810 may perform the design methods discussed in the present disclosure to generate the design layout 850 including the modified circuit. In some embodiments, the design subsystem 810 is configured to use a circuit design procedure to generate the design layout 850. The design subsystem 810 may further include one or more steps, such as logic design, physical design, pre-layout simulation, placement and routing, timing analysis, parameter extraction, design rule check and post-layout simulation, to generate the design layout 850. The design layout 850 may be converted from description texts to visual equivalents to show a physical layout of the depicted patterns, such as the dimensions, shapes, and locations thereof. In an embodiment, the design layout 850 can be expressed in a suitable file format such as GDSII, DFII, OASIS, or the like.

The mask subsystem 820 receives the design layout 850 from the design subsystem 810 and manufactures one or more masks (photomask, lithography masks, or reticles) according to the design layout 850. In some embodiments, the mask subsystem 820 includes a mask data preparation block 822, a mask fabrication block 824 and a mask inspection block 826. The mask data preparation block 822 modifies the design layout 850 so that a revised design layout 860 can allow a mask writer to transfer the design layout 850 to a writer-readable format.

The mask fabrication block 824 is configured to fabricate the one or more masks by preparing a substrate based on the design layout 860 provided by the mask data preparation block 822. A mask substrate is exposed to a radiation beam based on the pattern of the revised design layout 860 in a writing operation, which may be followed by an etching operation to leave behind the patterns corresponding to the design layout 860. In some embodiments, the mask fabrication block 824 includes a checking procedure to ensure that the design layout 860 complies with requirements of a mask writer and/or a mask manufacturer to generate the mask as desired. An electron-beam (e-beam), multiple e-beams, an ion beam, a laser beam or other suitable writer source may be used to transfer the patterns.

After the one or more masks are fabricated, the mask inspection block 826 inspects the fabricated masks to determine if any defects, such as full-height and non-full-height defects, exist in the fabricated mask. If any defects are detected, the mask may be cleaned or the design layout in the mask modified.

The fabrication subsystem 830 is an IC manufacturing entity that includes multiple manufacturing facilities or tools for the fabrication of a variety of the IC devices 880. The fabrication subsystem 830 uses the mask fabricated by the mask subsystem 820 to fabricate a wafer 870 having the IC devices 880 thereon. The wafer 870 includes a semiconductor substrate and optionally various layers formed thereon. The operations provided by the manufacturing facilities or tools may include, but are not limited to, photolithography, deposition, sputtering, etching, diffusion, ion implantation, or annealing. In some embodiments, test structures may be formed on the wafer 870 to generate test data indicative of the quality of the fabricated wafer 870. In some embodiments, the fabrication subsystem 830 includes a wafer testing block 832 configured to ensure that the wafer 870 conforms to physical manufacturing specifications and mechanical and/or electrical performance specifications. After the wafer 870 passes the testing procedure performed by the wafer testing block 832, the wafer 870 may be diced (or sliced) along the scribe line regions to form separate IC devices 880. The dicing process can be accomplished by scribing and breaking, by mechanical sawing (e.g., with a dicing saw), or laser cutting.

FIG. 8B is a schematic diagram of the design system (e.g., the design subsystem 810 of FIG. 8A) for implementing or storing the circuits discussed, in accordance with some embodiments of the present disclosure. The design system includes a processor 801, a network interface 803, an input/output (I/O) device 805, a storage device 807, a memory 809, and a bus 808. The processor 801 is configured to communicate with the network interface 803, the I/O device 805, storage device 807, and memory 809 through the bus 808.

The processor 801 is configured to execute program instructions that include a tool configured to perform the design methods as described and illustrated with reference to figures of the present disclosure so as to generate the design layouts including the modified circuits.

The network interface 803 is configured to access program instructions and data accessed by the program instructions stored remotely through a network (not shown).

The I/O device 805 includes an input device and an output device configured for enabling user interaction with the design subsystem 810. In some embodiments, the input device includes, for example, a keyboard, a mouse, and other devices. Moreover, the output device includes, for example, a display, a printer, and other devices.

Storage device 807 is configured for storing the modified circuits, the design layouts, one or more cell libraries including the configurations and settings of the standard cells as discussed previously, program instructions and data accessed by the program instructions. In some embodiments, the storage device 807 includes a non-transitory computer-readable storage medium, for example, a magnetic disk and an optical disk.

The memory 809 is configured to store program instructions to be executed by the processor 801 and data accessed by the program instructions. In some embodiments, the memory 809 includes any combination of a random access memory (RAM), some other volatile storage device, a read-only memory (ROM), and some other non-volatile storage device.

According to some embodiments, a design method is provided. Design data of a circuit is received, and the circuit is configured to perform a function. A simulation is performed based on the design data of the circuit to obtain an output corresponding to the function. The circuit is modified by adding additional devices in series with at least one problematic transistor in the circuit when random telegraph noise (RTN) of the output does not meet a design specification. A layout of the modified circuit is generated when the RTN of the output of the modified circuit meets the design specification.

According to some embodiments, another design method is provided. Design data of a circuit is received, and the circuit is configured to perform a function. A simulation is performed based on the design data of the circuit to obtain an output corresponding to the function. The circuit is modified by replacing a first problematic transistor with a P-type transistor in the circuit when random telegraph noise (RTN) of the output does not meet a design specification. A layout of the modified circuit is generated when the RTN of the output of the modified circuit meets the design specification. The first problematic transistor is an N-type transistor.

According to some embodiments, yet another design method is provided. Design data of a circuit is received, and the circuit is configured to perform a function. A simulation is performed based on the design data of the circuit to obtain an output corresponding to the function. A plurality of problematic transistors are identified in the circuit when random telegraph noise (RTN) of the output does not meet a design specification. A plurality of additional devices are added to modify the circuit according to the problematic transistors. The additional device is a transistor or a resistor.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A design method, comprising:
receiving design data of a circuit configured to perform a function;
performing a simulation based on the design data of the circuit to obtain an output corresponding to the function;
modifying the circuit by adding additional device in series with at least one problematic transistor in the circuit when random telegraph noise (RTN) of the output does not meet a design specification; and
generating a layout of the modified circuit when the RTN of the output of the modified circuit meets the design specification.

2. The design method of claim 1, further comprising:
identifying the problematic transistor from a plurality of transistors in the circuit.

3. The design method of claim 2, wherein identifying the problematic transistor from the transistors in the circuit further comprises:
selecting a plurality of first transistors from the transistors, wherein each of the first transistors is used as a switch; and
assigning one of the first transistors as the problematic transistor.

4. The design method of claim 1, wherein the additional device is a transistor or a resistor.

5. The design method of claim 1, wherein modifying the circuit by adding the additional device in series with the problematic transistor in the circuit when the RTN of the output does not meet the design specification further comprises:
inserting a P-type transistor between the problematic transistor and a power line when the problematic transistor is used as a switch connected to the power line; and
inserting a N-type transistor between the problematic transistor and an internal node when the problematic transistor is used as a second switch connected to a ground line.

6. The design method of claim 5, wherein the N-type transistor is smaller than the problematic transistor.

7. The design method of claim 1, wherein modifying the circuit by adding the additional device in series with the problematic transistor in the circuit when the RTN of the output does not meet the design specification further comprises:
inserting a first resistor between the problematic transistor and a power line when the problematic transistor is used as a first switch connected to the power line; and
inserting a second resistor between the problematic transistor and a signal line when the problematic transistor is used as a second switch connected to a ground line.

8. The design method of claim 1, wherein the problematic transistor is an N-type transistor.

9. The design method of claim 1, further comprising:
generating a layout of the circuit when the RTN of the output of the circuit meets the design specification.

10. A design method, comprising:
receiving design data of a circuit configured to perform a function;
performing a simulation based on the design data of the circuit to obtain an output corresponding to the function;
modifying the circuit by replacing a first problematic transistor with a P-type transistor in the circuit when random telegraph noise (RTN) of the output does not meet a design specification; and
generating a layout of the modified circuit when the RTN of the output of the modified circuit meets the design specification,
wherein the first problematic transistor is an N-type transistor.

11. The design method of claim 10, further comprising:
modifying the circuit by adding additional device in series with a second problematic transistor in the circuit when the RTN of the output does not meet the design specification,
wherein the additional device is a transistor or a resistor.

12. The design method of claim 11, further comprising:
identifying the first and second problematic transistors from a plurality of transistors in the circuit,
wherein each of the first and second problematic transistors is a transistor used as a switch.

13. The design method of claim 11, wherein modifying the circuit by adding the additional device in series with the second problematic transistor in the circuit when the RTN of the output does not meet the design specification further comprises:
inserting a P-type transistor between the second problematic transistor and a power line when the second problematic transistor is used as a switch connected to the power line; and
inserting a N-type transistor between the second problematic transistor and an internal node when the second problematic transistor is used as a second switch connected to a ground line.

14. The design method of claim 11, wherein modifying the circuit by adding the additional device in series with the second problematic transistor in the circuit when the RTN of the output does not meet the design specification further comprises:
inserting a first resistor between the second problematic transistor and a power line when the second problematic transistor is used as a first switch connected to the power line; and
inserting a second resistor between the second problematic transistor and a signal line when the second problematic transistor is used as a second switch connected to a ground line.

15. The design method of claim 10, further comprising:
generating a layout of the circuit when the RTN of the output of the circuit meets the design specification.

16. A design method, comprising:
receiving design data of a circuit configured to perform a function;
performing a simulation based on the design data of the circuit to obtain an output corresponding to the function;
identifying a plurality of problematic transistors in the circuit when random telegraph noise (RTN) of the output does not meet a design specification; and
adding a plurality of additional devices to modify the circuit according to the problematic transistors,
wherein the additional device is a transistor or a resistor.

17. The design method of claim 16, wherein identifying the problematic transistors in the circuit when the RTN of the output does not meet the design specification further comprises:
selecting a plurality of first transistors from transistors in the circuit, wherein each of the first transistors is used as a switch; and
assigning the first transistors as the problematic transistors.

18. The design method of claim 16, wherein adding the additional devices to modify the circuit according to the problematic transistors further comprises:
inserting a P-type transistor between a first problematic transistor of the problematic transistors and a power line when the first problematic transistor is used as a switch connected to the power line; and
inserting a N-type transistor between a second problematic transistor of the problematic transistors and an internal node when the second problematic transistor is used as a second switch connected to a ground line.

19. The design method of claim 16, wherein adding the additional devices to modify the circuit according to the problematic transistors further comprises:
inserting a first resistor between a first problematic transistor of the problematic transistors and a power line when the first problematic transistor is used as a first switch connected to the power line; and
inserting a second resistor between a second problematic transistor of the problematic transistors and a signal line when the second problematic transistor is used as a second switch connected to a ground line.

20. The design method of claim 16, wherein the problematic transistors are N-type transistors.
